(19) United States
(12) Patent Application Publication
(10) Pub. No.: US 2002/0078134 A1
(43) Pub. Date: Jun. 20, 2002

(54) Push-based web site content indexing

(76) Inventors: Alan E. Stone, Morristown, NJ (US); Samuel Mazza, Fort Lee, NJ (US)

Correspondence Address: Gregory D. Caldwell, BLAKELY SOKOLOFF TAYLOR & ZAFMAN LLP, 12400 Wilshire Boulevard, 7th Floor, Los Angeles, CA, 90025, US

(21) Appl. No.: 09/737,948

(22) Filed: Dec. 18, 2000

(51) Int. Cl. G06F 15/16

(52) U.S. Cl. 709/202

(57) ABSTRACT

Various embodiment of a technique for pushed-based indexing of web content are described.

### FIELD

The invention generally relates to web search engines and indexing, and in particular, to a technique for push-based web site content indexing.

### BACKGROUND

Today, the Internet is indexed via web ‘spiders’. Typically, dedicated machines relentlessly visit all the publicly addressable Internet addresses to gain access to the Hyper-Text Transfer Protocol (HTTP) port number 80 to find “home pages” or “web pages.” HTTP is a standard protocol, for example, Hypertext Transfer Protocol (HTTP)- -HTTP/1.1, Request For Comments 2616, June 1999. Once found, the spider navigates through the content of each ‘page’, indexing both content and hyperlinks. It uses the content (and sometimes the hyperlinks) of these pages to perform inferencing on the data. The inferencing is typically a heuristic (e.g., algorithm) or collection of heuristics that create a search engine specialized for the needs of the engine provider. Different search engine providers have different specialties, and hence, have different inferencing heuristics.

The links collected by the indexer are in turn used to feed the indexer to other pages. In some cases, it is this feedback mechanism that keeps an indexer relentlessly navigating through the web. This technique is where the term ‘spidering’ comes from as it personifies the indexer as a spider crawling through a web of pages. There are likely cycles that form (where there are web pages with links to each other that may cause an indexer to go in circles). Some indexers keep track of such cycles and “trim” them so as to prevent itself from for example revisiting the home-page link of almost every other page within that web. This is just one simple example of the complexities that indexers face.

FIG. 1 is a block diagram of a typical web indexer. Today, indexers use a “pull” method to index the web. That is, they use the above-mentioned methods to go around and poll and retrieve content from every accessible page on the Internet (e.g., using HTTP “Get” messages). This is called pulling, because, for all intensive purposes, every single page in the web eventually finds itself “pulled” through the Internet to the indexer typically located at the indexer's site (or perhaps multiple sites). The indexing heuristics or indexing programs reside on the indexer, and there are limited provisions are made to distribute this load in today's methods. The most common technique is to provide multiple indexers spread throughout the world.

There are some variations to this that help the indexer's performance and efficiency. For example, a program or web browser may visit a search engine, and add a web site to the engine. This assures that the indexer will be knowledgeable about the web site and be sure to visit it, instead of relying on a link somewhere else in the Internet to find the web site. There are of course many other methods of finding sites as well. Regardless, eventually, the indexer still has to “pull” every page through itself and index it.

There are several problems with the above-mentioned approach to web indexing.

Index Intervals—It must take a very long time to visit every page on the Internet and index it. Some sites claim they index over 1 billion pages!

Bandwidth Consumption—The main bottleneck in indexing so many pages is getting them to the indexer. The index interval is directly related to the performance of the site being indexed, the bandwidth between the site and the indexer, and the speed of the indexer.

Stale Pages—Because of the large time intervals in traversing so many pages, the indexer is not always up to date with changes on pages.

Broken Links—Similar to stale pages, due to the delay or large time intervals, web pages may altogether just disappear or move, hence presenting false hits to the search engine user or to the feedback loop that continues to move the indexing spider along its search traversals.

Thus, an improved technique is desirable.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and is not limited thereto. The spirit and scope of the present invention is limited only by the terms of the appended claims.

The following represents brief descriptions of the drawings, wherein:

FIG. 1 is a block diagram of a typical web indexer.

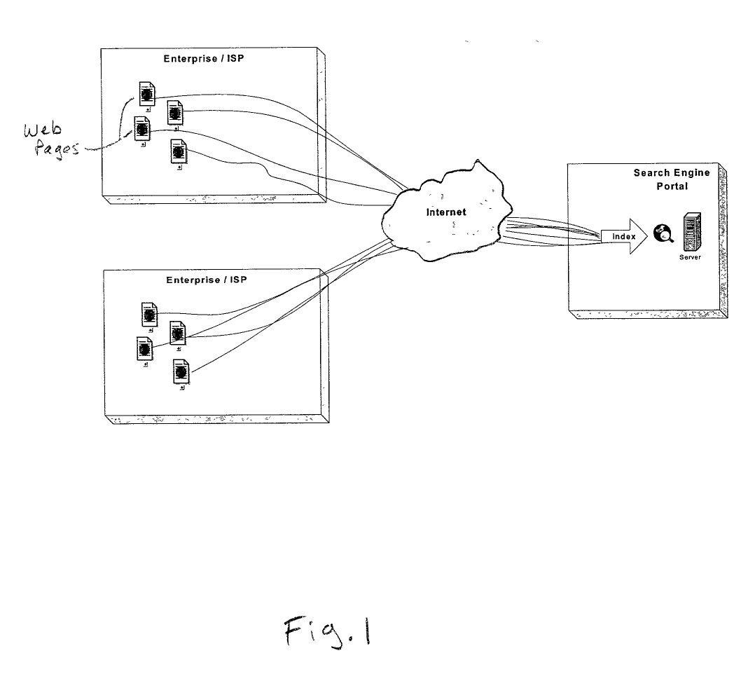

FIG. 2 is a block diagram illustrating push-based content indexing according to an example embodiment.

FIG. 3 is a block diagram illustrating aspects of a push-based content indexing including pushing web content changes according to an example embodiment.

FIG. 4 is a flow chart illustrating operation of a push-based technique according to an example embodiment.

FIG. 5 is a flow chart that illustrates operation of a push-based technique according to another example embodiment.

FIG. 6 is a diagram illustrating generation of digests according to an example embodiment.

FIG. 7 is a diagram illustrating an example graph or web topology for a local web domain according to an example embodiment.

### DETAILED DESCRIPTION

I. “Push-Based” Indexing According to An Example Embodiment

According to an example embodiment, a push-based web site indexing technique is provided to accelerate and improve the accuracy of web indexing capabilities for the Internet. This new technique may be used to improve the way the Internet is indexed. Instead of performing the “pull” model described above, a “push” based approach is used to index the Internet.

According to an example embodiment, local web site hosts or service providers, whether they are Internet Service Providers (ISPs), Enterprises, portals, data centers, hosting facilities, etc., contain local indexing capabilities that index their web domains locally, rather than being indexed remotely over the Internet, which can be very time consuming and uses significant bandwidth. These local indexing functions will be referred to as Domain Indexers. The Domain Indexers visit web pages within the specified local web domain, and index the web pages and hyperlinks. Each of the Domain Indexers then transmits or pushes the index for the local web domain back to a central location, such as to an index aggregator which may be located at a search engine provider's site, This function may be performed, for example, by an Internet Appliance, or simply by a software function running in the web domain, such as an indexing software program running on one or more web servers in the local web domain or serving the local web domain. As noted, the web domain indexing function is referred to herein as a Domain Indexer.

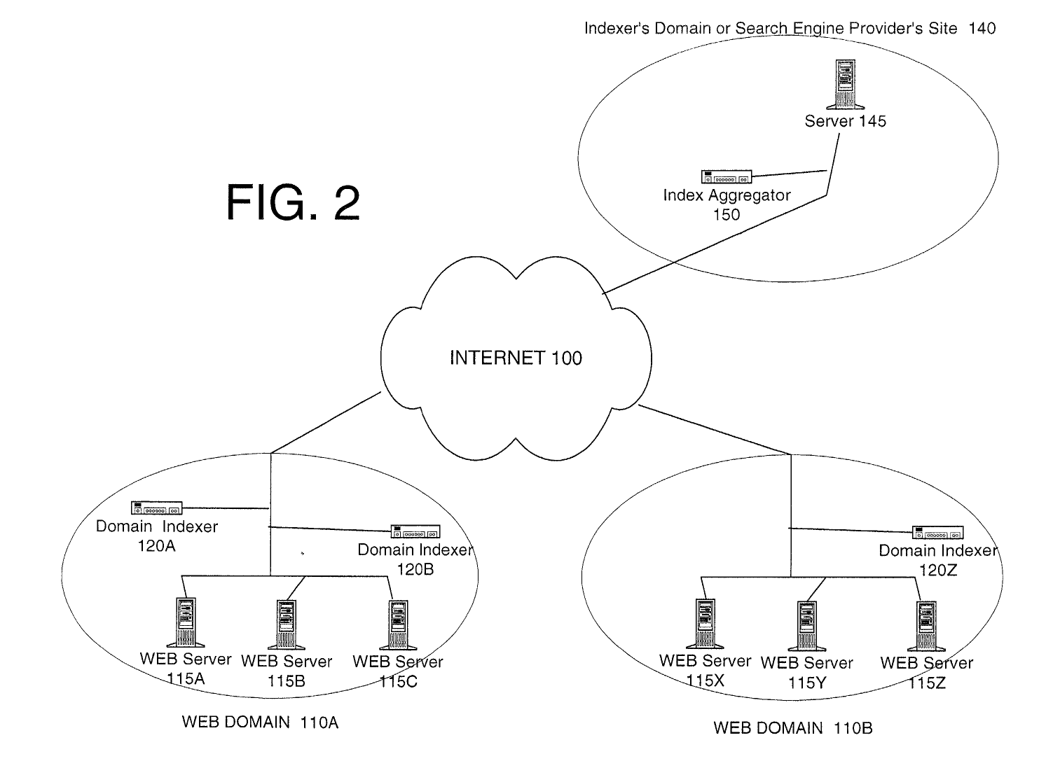

FIG. 2 is a block diagram illustrating push-based content indexing according to an example embodiment. Local web domains 110A and 110B are coupled to an indexer's domain or a search engine provider's site 140 via the Internet 100 or other network. Referring to FIG. 2, the local web domain 110A includes web servers 115A, 115B and 115C to store web pages, and one or more Domain Indexers, such as Domain Indexers 120A and 120B. Similarly, local web domain 110B includes web servers 115X, 115Y and 115Z. Local web domain 110B also includes one or more Domain Indexers 120, including Domain Indexer 120Z. Each Domain Indexer 120 indexes the web content and hyperlinks of web pages within their local web domain.

A local web domain may include any set of web content, such as a group of web servers at a physical site or within a particular geographic region or building, or a group of web servers provided by a particular data center or web hosting service. More commonly, a local web domain may be all or part of the addressable web content in a particular web domain or associated with a portion of a particular address or Uniform Resource Locator (URL). For example, a local web domain 110 may include all (or part) of the addressable web content available at “Dialogic.com” or at “Intel.com”, without regard to physical location of the web servers for that domain. These are just a few examples of web domains. In an example embodiment, all or some of the servers in that local web domain may be connected together via a Local Area Network (LAN) or Intranet to allow the Domain Indexer 120 to search and index all the web pages in that local web domain much faster than performing this function over the Internet. For example, the web content for the local web domain “Dialogic.com” may be stored on web servers located in New Jersey, California and New Zealand. However, all of this web content (stored in New Jersey, California and New Zealand) may be considered part of the same local web domain that is indexed by one or more Domain Indexers, according to one example embodiment. Thus, there may be one or more Domain Indexers 120 that index the web content for the local web domain Dialogic.com.

In a slightly different example embodiment, within the web domain “Dialogic.com,” there may be one or more Domain Indexers assigned to index content stored in each geographic region. As a result, within the web Domain “Dialogic.com,” there may be sub-Domains based on geography (e.g., different sub-domains for New Jersey, California and New Zealand) or different sub-Domains for certain lower level addresses or URLs under Dialogic.com, with one or more Domain Indexers assign to index content for each sub-domain. In this manner, each sub-domain may be considered as a distinct web domain, that is, separately indexed by a corresponding Domain Indexer(s).

Referring to FIG. 2 again, the indexer's domain or the search engine provider's site 140 includes a server 145 to store a master index, which may be for example, an index for many web domains, and other information used by the search engine. Site 140 also includes an index aggregator 150. According to an example embodiment, the Index Aggregator 150 receives a web content index and content change information from each of the Domain Indexers deployed throughout the Internet and generates an updated master web index for at least a portion of the Internet, including from multiple local web domains.

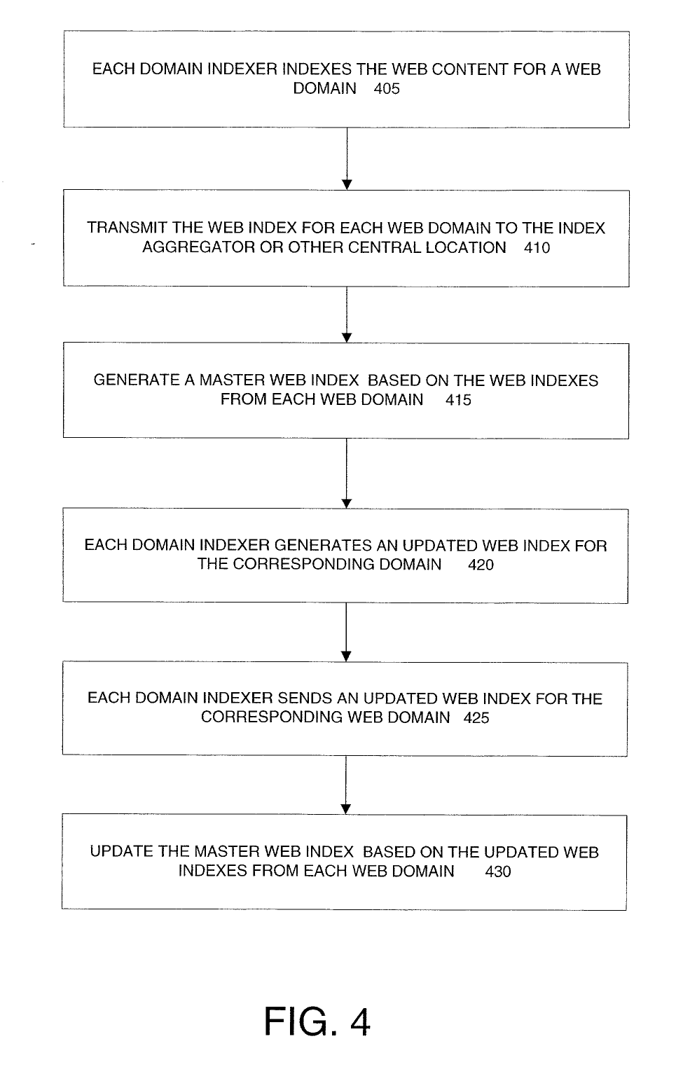

FIG. 4 is a flow chart illustrating operation of the push-based technique according to an example embodiment. Referring to FIG. 4, first each Domain Indexer 120 indexes the web pages from its local web domain, block 405, and then transmits or publishes this index to the Index Aggregator 150 via the Internet 100, block 410. At block 415, a search engine update program running on server 145 at search engine provider's site 140 generates a master web index for all or part of the Internet based on the web indexes received from each Domain Indexer 120 via Index Aggregator 150.

However, web content is constantly changing when new pages are added, old pages are removed or changed, hyperlinks are changed, etc. As a result, the search engine update program running on server 145 should periodically receive an updated web index or content change information. Therefore, in block 420, each Domain Indexer 120 re-indexes the web domain, or generates an updated web index for the domain. Each Domain Indexer 120 then sends an updated web Index to the Index Aggregator 150, block 425. The search engine update program running on server 145 at search engine provider's site 140 then generates an updated master web index based on the updated web indexes from each web domain, block 430.

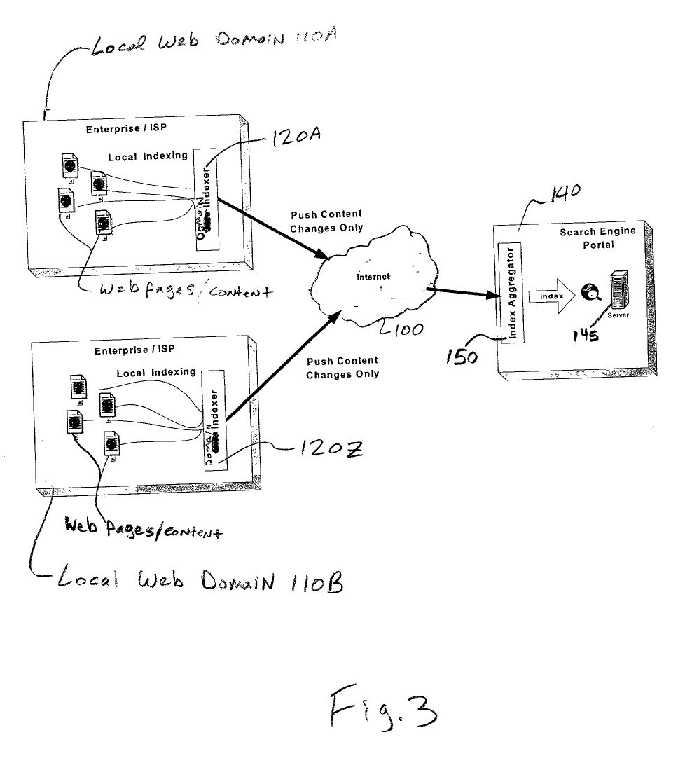

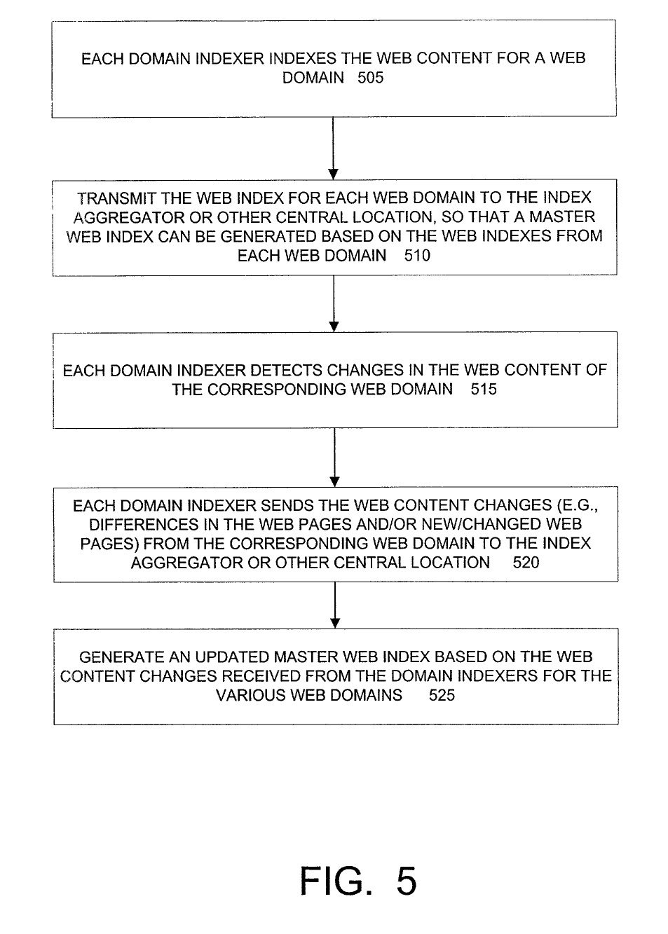

FIG. 5 is a flow chart that illustrates operation of the push-based technique according to another example embodiment. Rather than re-sending an updated web index, which typically would include a significant amount of unchanged web content), the example of FIG. 5 involves detecting changes or differences in the web domain, and then sending only these content changes or differences to the Index Aggregator. FIG. 3 is a block diagram illustrating aspects of the push-based content indexing including pushing or sending web content changes according to an example embodiment.

Referring to FIGS. 3 and 5, at block 505, each Domain Indexer 120 indexes the web content for a web domain. At block 510, each Domain Indexer 120 sends the web Index for the corresponding web domain to the Index Aggregator 150. A master web index may then be generated by the search engine update program running on server 145 at search engine provider's site 140, based on the indexes from each of the web domains received via Index Aggregator 150.

At block 515, each Domain Indexer 120 detects changes to the web content for the local or corresponding web domain. The changes in web content can include changes to any type of file used for web content, including changes to a web page or Hypertext Markup Language (HTML) page, a script or other program, such as a Java script, a graphic, or a link or hyperlink to another file or page.

At block 520, each Domain Indexer 120 then sends the web content changes to the Index Aggregator 150 (or other location). These content changes can be sent to the Index Aggregator 150 as one or more new or updated files, such as new or updated web pages, scripts, graphics if changed, and/or the differences between the old content and the new content, such as that detected in block 515. According to an example embodiment, the differences can be provided as the differences between the old file, such as web pages, scripts or graphics, and a new file. A new index can then be generated from the old index and the content changes or differences. According to an example embodiment, for each changed file of the web content, either the new or updated file (such as web page, script, graphic), or the difference between the new file and old file is transmitted by the Domain Indexer 120 to the Index Aggregator 150, whichever is less or more preferable.

At block 525, the Index Aggregator 150 and/or server 145 generates an updated master web index based upon the old master web index and the web content changes received from each Domain Indexer 120.

As described above, according to an example embodiment, each Domain Indexer 120 detects changes in the web content of its local web domain. Each Domain Indexer 120 then pushes or transmits these web content changes to the Index Aggregator 150, for use by a search engine update program in updating a master web index that encompasses indexes from a group (or plurality) of local web domains. The web content changes or even the updated indexes may be transmitted or pushed from each of the Domain Indexers 120 to the Index Aggregator 150 using a well known protocol or communication technique. For example, the web content changes or new indexes can be sent to the Index Aggregator 150 using File Transfer Protocol (FTP), Request For Comments 959, October, 1985. Many other techniques can be used.

According to another example embodiment, and as described in greater detail below, a specialized protocol, such as a protocol referred to herein as Index Exchange Protocol (IEP), may be used to provide push-based content indexing from the Domain Indexers 120 to the Index Aggregator 150. A content schema may also be used to provide XML (Extensible Markup Language) based indexing (indexes and/or content change information) and inferencing information. Other formats, in addition to XML, can be used as well. The techniques described herein can be implemented in hardware, software or combinations thereof.

For example, the index or the web content change information may be provided in a format that is specified by a validation template, such as a Document Type Definition (DTD) or a schema, as agreed upon between the Domain Indexers 120 and the Index Aggregator 150. XML, or Extensible Markup Language v. 1.0 was adopted by the World Wide Web Consortium (W3C) on Feb. 10, 1998. XML provides a structured syntax for data exchange. XML allows a document to be validated against a validation template. A validation template defines the grammar and structure of the XML document (including required elements or tags, etc.). There can be many types of validation templates such as a document type definition (DTD) in XML or a schema, as examples. These two validation templates are used as examples to explain some features according to example embodiments. Many other types of validation templates are possible as well. A schema is similar to a DTD because it defines the grammar and structure which the document must conform to be valid. However, a schema can be more specific than a DTD because it also includes the ability to define data types, such as characters, numbers, integers, floating point, or custom data types.

II. How Push Indexing Works According to An Example Embodiment

According to an example embodiment, two functions may be provided to implement a push-based web indexing technique, including: 1) a Domain Indexer 120 for each of the local web domains, which may be, for example, at or near or the local web domain, and 2) an Index Aggregator 150, which may be provided for example at the web page indexer's premises. These systems or functions may be provided as Internet Appliances, servers, software, or other types of devices or systems, for example, and may work together to significantly improve the overall performance and accuracy of Internet web site indexing. The systems or functions, such as the Domain Indexers 120 and Index Aggregator 150, may communicate and work together using existing or well known protocols, or using new protocols (i.e., IEP), layered on top of and compatible with existing Internet protocols, and provide a different methodology of web indexing than is performed today.

According to an example embodiment, the new protocol, referred to herein as IEP, may provide the logical connectivity between Domain Indexers 120 and Index Aggregators 150 (there can be multiple Index aggregators 150 as well). IEP, for example, can be layered on top of Transmission Control Protocol (TCP), to provide standard integration into the Internet infrastructure. The IEP allows Domain Indexers 120 to advertise themselves to the Index Aggregator 150, and to allow Index Aggregators 150 to advertise themselves to Domain Indexers 120, and for allowing the Domain Indexers 120 to transfer or transmit or push index content to the Index Aggregator 150 via the Internet 100 or another network.

According to an example embodiment, two primary functions comprise push indexing. A Domain Indexer 120 is used to perform domain-centric, intelligent, autonomous indexing of page content, for example, to index web page content for a specific local web domain. The other, an Index Aggregator 150, is used to collect web indexes and content change information from various Domain Indexers 120 and collaborate with Domain Indexers 120 throughout the Internet. According to an example embodiment, a master web index is generated and maintained by a search engine update program running on the server 145 at the search engine provider's site 140. According to an example embodiment, the Index Aggregator 150 may receive and pre-process the updated index or content change information from each Domain Indexer 120, and then pass these processed indexes or content change information to the search engine update program running on server 145 at site 140 (for example).

According to an example embodiment, push indexing takes advantage of a divide and conquer approach to solving the problem of indexing such a huge number of web pages. Instead of performing indexing on a single machine or a collection of collocated but typically remote machines, this approach instead uses a distributed computing approach. A technique of the present invention solves the indexing problem in much smaller pieces, but in larger numbers, distributed throughout the Internet. Efficiencies are gained via the division of labor across all the Domain Indexers 120, for example, wherein one or more Domain Indexers 120 are assigned to each local web domain.

According to one example embodiment, Domain Indexers 120 detect . changes in the web content in the domain they are servicing and relay changes as they happen to the Index Aggregator 150. Hence, only delta bandwidth is required, which is the bandwidth required to transmit only the changes to web content, to keep web indexers 120 current with the domains that are indexed with this approach. The Index Aggregator 150 simply “listens” to changes or detects changes occurring within it local web domain and records them, and then transmits these web content changes to Index aggregator 150. This is much more efficient than constantly reviewing every page on the Internet and regenerating a entirely new index.

III. A Domain Indexer According to An Example Embodiment

The Domain Indexer 120 is a function that may be distributed throughout the Internet, with Domain Indexers 120 being provided for each local web domain 110, for example, as shown in FIG. 2. One purpose of the Domain Indexer 120 is to decompose the problem of indexing sites or web domains into manageable pieces that can operate in parallel, thus significantly improving the overall web index interval rate. In addition, further efficiency can sometimes be obtained by acting locally, for example, over a LAN or Intranet, rather than through the general Internet, where latencies can be much greater or more unpredictable.

There are many different techniques that can be used to detect differences or changes in the web content. A brute force comparison of all or some of the bits or data in each file or web page can be done, such as a comparison of an old page to a new page, or other more efficient techniques can be used.

One example technique that can be used is to calculate a content indicator for each file or web page and record this content indicator. A content indicator may be anything that allows the Domain Indexer to detect a change or update to the content of the web pages. According to an example embodiment, a content indicator, when compared to another content indicator for the same web page, provides an indication as to whether or not the content of the web page has been changed or updated. When indexing a web domain 110, a Domain Indexer 120 may calculate a new content indicator for a new copy of a web page. The Domain Indexer 120 may then compare the new content indicator for the new copy of a web page to the previous content indicator of the same web page to determine if the web page content has changed. Alternatively, the content indicators may be calculated by the various web authoring tools or other programs, and stored within each web page for reading by the Domain Indexers 120.

A content indicator may include, for example, a file size of the web page, a date that the web page was last modified or changed, and a file digest. When a digest is calculated for a web page, a digest function takes an arbitrary sized message or file, such as a web page, and generates a number, which is typically a fixed length quantity. A hash algorithm or hash function, also known as a message digest is typically a one-way function. It is considered a function because it takes an input message and produces an output. It may be considered one-way because it is not practical to figure out what input corresponds to a given output. If it is cryptographically secure, it should be impossible to find two messages or files that have the same file digest. Thus, if a change is made to a web page, the digest for that page will change. The digest may be calculated, for example, using message digest algorithms, including MD2, MD4 and MD5, and documented in Request for Comments 1319, 1320, 1321, respectively. Other algorithms, such as hash functions or Cyclic Redundancy Checks (CRC) algorithms, etc. may be used to generate the file digests. The term digest will be used hereinbelow in the various embodiments and examples. However, other types of content indicators may be used as well.

The Domain Indexer 120 may continuously read or traverse web pages and files within the web domain and calculate the digest for each file or web page. The newly calculated digest can then be compared to the stored digest for the same web page or file, As noted above, rather than being calculated by the Domain Indexer 120, the file digests may be calculated by another program, such as a web authoring tool or program, and stored in each web page for review by the Domain Indexer 120. If these two digests are the same, then this indicates that the web page or file probably has not changed. If these two digests are different, this indicates that the web page or file probably has changed. The changed file or web page, or the specific change or difference between the two web pages can be stored for transmission to the Index Aggregator 150. As noted above, these web content changes can be provided as copies of just the new or changed web pages or files, or as only the differences between the old and new files or web pages, for example, depending on which is less for that file or web page or which is preferable for transmission.

According to an example embodiment, the Domain Indexer 120 may perform one or more of the following functions:

Identifies the topology of the web in the local web domain 110 it services.

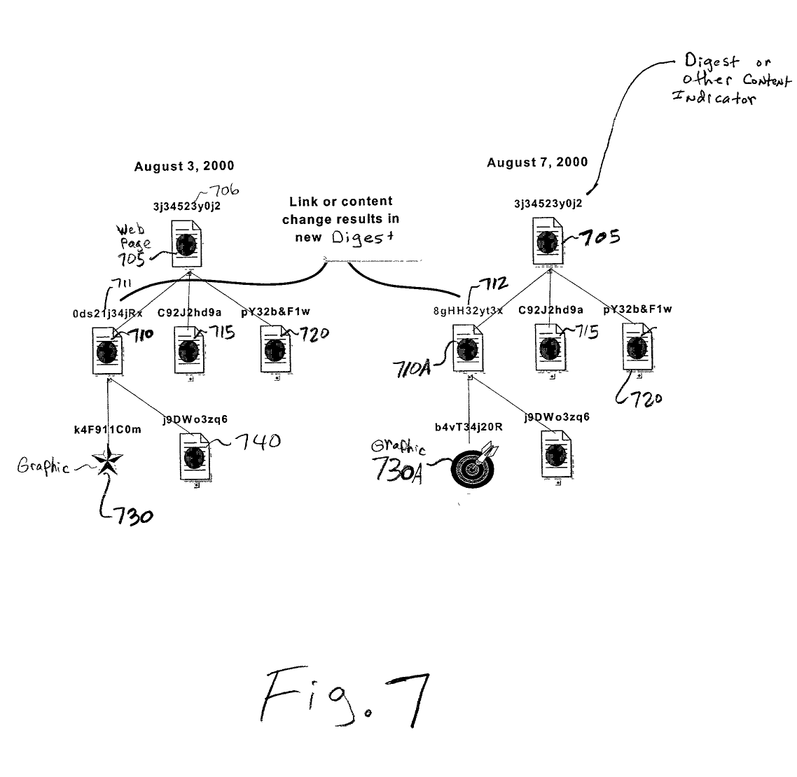

Creates and records a graph representing the web content interconnects or hyperlinks and the files for the web content in the local web domain; Each node in the graph represents a file, such as a web page, a script or a graphic for example; An example illustration of a graph is shown in FIG. 7.

Assigns and maintains digests for each node or file in the graph indicating the identification of the node or file (web page, script, graphic, etc); a change in the digest for a file or node or web page indicates that the web page or file has changed. Thus, a change in the digest indicates to the Domain Indexer 120 that these web content changes or differences should be sent to the Index Aggregator 150 so that the master index can be updated.

Performs graph traversals throughout the web content in the local web domain to efficiently determine changes in the local web domain that the Domain Indexer 129 services.

Performs web page indexing based on either a stock or standard heuristic or algorithm, or a pluggable heuristic (software program) provided by a search engine provider domain 140 or a software provider. The search engine provider can electronically transmit the Domain Indexer program (including the search heuristics or algorithm) over the Internet 100 (for example), which is then downloaded by the Domain Indexer 120 for searching the local web domain. The Domain Indexer 120 can execute multiple indexing algorithms from different vendors.

Formats the index content or the web content changes into an XML format, for example, according to a DTD or schema agreed upon by the Domain Indexer 120 and Index Aggregator 150, for transmittal to an Index Aggregator 150.

Publishes or transmits the changes of the local web domain to the directed web search engine Index Aggregator 150

The Domain Indexer 120 is responsible for determining the web topology of the local web domain 110 it is servicing. After completely surveying the local web domain 110, a graph is built that represents the pages and all the links between pages. The graph is ‘trimmed’, or otherwise managed, to remove cycles, such as web pages that have links to each other. The topology of the domain can be constantly, periodically or occasionally surveyed by the Domain Indexer 120 to detect changes. There are a number of well known or existing algorithms that can be used for topology discovery.

Once the topology of the locally hosted web or webs (referred to as the local web domain 110) is identified, special digests are assigned to each node if not already assigned, where each node represents a page or file, such as a web page, script or graphic. The digest may be created via any of several possible algorithms, such as a hash function, Message Digest algorithm (such as MD5), Cyclic Redundancy Check (CRC), etc.

The page digest generator will be able to generate digests for both text and/or graphics content, scripts (such as a Java script), etc. Hence, a change to a graphic image via a link could also be determined based on a change or difference in digests for that page (the digest for that web page before the change as compared to the digest for that web page after the change).

This technique can be used by the Domain Indexer 120 to quickly sweep through the web pages of the local web domain to identify changes in the graph, thus further accelerating identification of the changed pages to be indexed. The Domain Indexer will load each page, calculate the new digest for the page if necessary, and compare it with the digest in the graph (the previous or existing digest for that page or file). Alternatively, the Domain Indexer may just read the digest or other content indicator, if already present in the file or web page, and then compare it to the previous digest or content indicator in the graph or domain representation. If the current and previous digests for the file or web page are different, the changes are recorded and the graph is updated with the new digest for that page. The changes can be recorded by the Domain Indexer 120 as a copy of the new web page (or file), or as only the differences between the old web page and the new web page, for transmission to the Index Aggregator 150. If the digests are the same, no changes are presumed made and the page is quickly discarded to move on to the next web page or file in the local web domain.

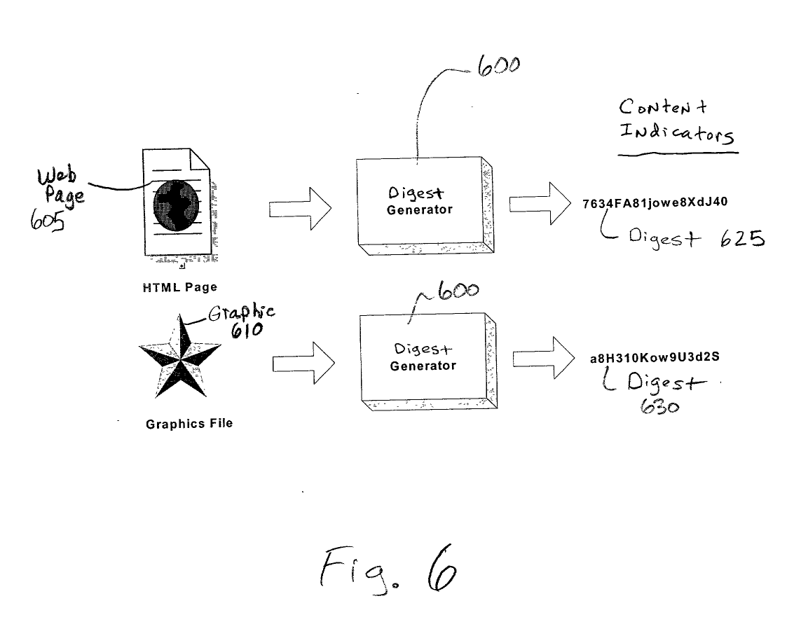

FIG. 6 is a diagram illustrating generation of digests according to an example embodiment. According to one embodiment, a digest generator 600 may be provided as part of the Domain Indexer 120. Digest generator 600 generates a content indicator, such as a digest for each file, such as for each web page, graphic or script, within the local web domain using any of several algorithms mentioned above. In this example shown in FIG. 6, digest 625 is generated for web page 605 and digest 630 is generated for graphic 610. As noted above, these digests can be generated by Domain Indexer 120, or may be generated by another program, such as during the creation or editing of the file, and then stored in the file for reading by the Domain Indexer 120.

FIG. 7 is a diagram illustrating an example graph or web topology for a local web domain according to an example embodiment. Graphs or web content are illustrated in FIG. 7 for two dates (Aug. 3 and Aug. 7, 2000). The digests for each node or file are also shown. For the web content as of Aug. 3, 2000, a web page 705 includes an digest 706. Web page 705 includes hyperlinks to web pages 710, 715 and 720. Web page 710 includes a digest 711. Web page 710 includes a graphic 730 and a hyperlink to web page 740.

Looking at the web content dated August 7, 2000 in FIG. 7, one or more link changes or content changes has resulted in digests for some nodes to be changed. Web page 710 has been changed and is labeled as web page 710A. The digest for web page 710A is digest 712, which is different than the digest 711 for web page 710. The difference in digests 712 and 711 indicates that web pages 710 and 710A are different. Similarly, graphic 730 has been replaced by new or updated graphic 730A. As a result, the digests for graphics 730 and 730A are different as well.

Since a Domain Indexer 120 may use a representation of a web domain, such as a tree or graph of hyperlinked documents and their associated digests, further acceleration or improvement in efficiency can be achieved by providing digests of other digests. An internal representation of the tree as shown in FIG. 7 for example could include an additional feature that would in turn provide a digest of digests of each of the nodes in the tree. Then, through tree traversal, changes can be quickly identified. For example, a top level web page, or a page for a root directory, etc., may have a digest, and may be used to determine if any of the lower level web pages or web pages within the top level web page have been changed. By just comparing the top level digests of two trees, the Domain Indexer 120 can quickly determine if the contents of any of the subordinate web pages have changed. If the top level digests are different, then the Domain Indexer 120 will then typically traverse the tree and perform comparisons of the lower level digests to identify the specific pages that have changed.

According to an example embodiment, a Domain Indexer 120 may be driven by policies (such as XML policies) that define constraints on the pages to be indexed in the domain of the Enterprise. An XML DTD can be defined to provide segmentation semantics to “segment” the Enterprise or local web domain into sets that have policies applied to them. Hence, segments could be explicitly excluded, possible because they are intended to be private to the Intranet and not candidates for publishing externally. According to an example embodiment, the XML policy is simply directed to the Domain Indexer 120 via a provisioned URL or address.

The Domain Indexer 120 may advantageously integrate with popular web servers including Microsoft's Internet Information Server, Apache Web Server, Netscape's iplanet Server, and Sun's Java Server. These integration capabilities might provide additional features that could make indexing faster, more reliable, and provide better control of content segmentation. For example, by using Microsoft's Internet Information Server (IIS) Application Programming Interfaces (APIs) remotely, the Domain Indexer 120 may automatically identify webs or web content within the local web domain without the need for performing port scans on internal servers.

The Domain Indexers 120 may also include the ability to “inherit” policy control from the controlling enterprise (the local web domain) directory service(s). This feature may allow the Domain Indexer 120 to automatically identify or “learn” publishing rights. For example, the Domain Indexer 120 can use the policies of the local web domain to determine constraints as to which portions of the local web domain should be indexed, for example, public portions of the web domain should be indexed, but private or Intranet portions are not accessible by the public and should not be indexed. This could aid in the constraint based indexing access control capabilities mentioned above. In addition, some directory services such as Novell's NDS (Novell Directory Service) provide provisions to provide policy information that could also be used to further constrain the indexing based on those policies. Some examples of the policies provided by NDS include; organization groups within the company, relationships between your company and others, roles of servers and their contents, roles of users or publishers of content.

IV. An Index Aggregator According to An Example Embodiment

One purpose of the Index Aggregator 150 is to provide a peer link from the search engine provider's site 140 (FIGS. 2, 3) to the Domain Indexers 120. This link between the Domain Indexers 120 and the search engine provider's site allows the search engine provider to distribute indexing algorithms to each Domain Indexer, and allows Domain Indexers 120 to transmit indexes and content change information for a local web domain to the search engine provider's site 140. The indexes and content change information can then be used by the search engine update program or another program to update a master web index. The Index Aggregator 150 could be implemented either as a separate piece of hardware running the IEP or other protocol or as a software package running on a server 145 (for example) with Internet connectivity.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
assigning at least one domain indexer to each of a plurality of web domains;
each of the at least one domain indexers indexing web content of the associated web domain; and
one or more of the domain indexers sending an index for the associated web domain to a predetermined destination.

2. The method of claim 1 and further comprising:
each of the domain indexers detecting changes in the web content of the associated web domain; and
sending the web content changes to the predetermined destination.

3. The method of claim 1 and further comprising using the web indexes for each of the web domains to generate a master web index.

4. The method of claim 1 wherein sending the index comprises sending an index for the associated web domain to an index aggregator so that each index can be used to generate a master index.

5. The method of claim 2 wherein the web content changes are sent as one or more of:
updated or changed web pages; and
differences between old and new web pages.

6. The method of claim 2 wherein detecting changes in the web content of the associated web domain comprises:
comparing a new digest for the web page to an old digest for the web page.

7. The method of claim 2 wherein detecting changes in the web content of the associated web domain comprises:
generating an old digest for a web page;
generating a new digest for a later version of the web page; and
comparing the new digest to the old digest, wherein a difference between the two digests indicates that the web page has changed.

8. A method comprising:
comparing a content indicator of a new version of a file to a content indicator of an older version of the file;
determining whether the content of the file has changed based on the comparing:
sending updated file content information for the file to a predetermined location if the file has changed.

9. The method of claim 8 wherein the comparing comprises comparing an index of a new version of a file to an index of an older version of the file.

10. The method of claim 8 and further comprising generating an updated master index based on updated file content information.

11. The method of claim 8 wherein the sending comprises sending either the new version of the file or differences between new and old versions of the file to a predetermined location if the file has changed.

12. An apparatus comprising a domain indexer to compare a content indicator of a new version of a file to a content indicator of an older version of the file, to determine whether the content of the file has changed based on the comparing, and to send updated file content information for the file to a predetermined location if the file has changed.

13. The apparatus of claim 12 wherein the content indicators comprise file digests.

14. The apparatus of claim 12 wherein the content indicator comprises one or more of:
an indication of file size;
a time and/or date of when the file was updated; and
a file digest.

15. The apparatus of claim 12 wherein the updated file content information comprises at least one of:
the new version of the file; and
differences between new and old versions of the file

16. A system comprising a plurality of domain indexers, at least one domain indexer provided for each of a plurality of web domains, each domain indexer to compare a content indicator of a new version of a file to a content indicator of an older version of the file, to determine whether the content of the file has changed based on the comparing, and to send updated file content information for the file to a predetermined location if the file has changed.

17. The system of claim 16 wherein the content indicators comprise file digests.

18. The apparatus of claim 16 wherein the content indicator comprises one or more of:
an indication of file size;
a time and/or date of when the file was updated; and
a file digest.

19. The system of claim 16 and further comprising;
an index aggregator to receive the updated file content information from one or more index aggregators; and
an update program to update ate a master web index baseUupdated file content information from the one or more index aggregators.

20. The system of claim 16 wherein each of the web domains comprise one or more of the following:
servers at a physical location;
web content at a physical location;
addressable web content associated with a particular address or Uniform Resource Locator;
web content at a specific web site; and
web content stored within a specific geographic region.

21. An apparatus comprising a domain indexer that is assigned to a local web domain to perform web page indexing for the web content of the web domain, to send the web index to a predetermined location or address, to detect changes in the web content at the web domain, and to send the web content changes to the predetermined location or address.

22. The apparatus of claim 21 wherein the web domain comprises all or part of the addressable web content within a particular URL or address.

23. The apparatus of claim 21 wherein the web domain comprises all or part of the web content provided within a specific physical location.

24. The apparatus of claim 21 wherein the domain indexer is located at the same location or region as at least a portion of the web content for the web domain.

25. The apparatus of claim 21 wherein the web domain comprises all or part of the web content provided within a specific physical location.

26. An apparatus comprising a storage readable media having instructions stored thereon, the instructions resulting in the following when executed by a machine that is assigned to a local web domain:
performing web page indexing for the web content of the web domain;
sending the web index to a predetermined location or address;
detecting changes in the web content at the web domain; and
sending the web content changes to the predetermined location or address.

27. The apparatus of claim 26 wherein the detecting comprises:
comparing a content indicator of a new version of a file to a content indicat an older version of the file; and
determining whether the content of the file has changed based on the comparing.

28. The apparatus of claim 26 wherein the sending comprises sending the web content changes to an index aggregator.

29. The apparatus of claim 26 wherein the detecting comprises comparing a new digest of a plurality of files to a previous digest of the plurality of files.
